(19) United States
(12) Patent Application Publication
(10) Pub. No.: US 2012/0272157 A1
(43) Pub. Date: Oct. 25, 2012

(54) FILE PROCESSING SYSTEM AND MANAGEMENT DEVICE

(75) Inventors: Hiroki Tajima, Amagasaki-shi (JP); Katsuhiko Akita, Amagasaki-shi (JP); Shoji Imaizumi, Shinshiro-shi (JP); Kenro Hama, Amagasaki-shi (JP)

(73) Assignee: Konica Minolta Business Technologies, Inc., Chiyoda-ku (JP)

(21) Appl. No.: 13/441,361

(22) Filed: Apr. 6, 2012

(30) Foreign Application Priority Data
Apr. 19, 2011 (JP) 2011-093102

(51) Int. Cl. G06F 3/01; G06F 3/033

(52) U.S. Cl. 715/748

(57) ABSTRACT

A workflow file includes body data and information defining a user who can process the file. In a file processing system including a plurality of file processing devices each having a touch panel, when a first file processing device to which a first user who can process the workflow file logs in detects that a first gesture of identifying the workflow file and a second gesture of indicating a second user who will perform processing subsequently have been performed on the touch panel, the second user is identified based on the second gesture and the defining information, and a second file processing device corresponding to the second user is reported to that effect. When the second file processing device detects that a third gesture for making a request for processing of the workflow file has been performed, the second file processing device acquires the body data of the workflow file.

This application is based on Japanese Patent Application No. 2011-093102 filed with the Japan Patent Office on Apr. 19, 2011, the entire content of which is hereby incorporated by reference.

### BACKGROUND OF THE INVENTION

1. Field of the Invention

The present invention relates to a file processing system and a management device, and particularly to a file processing system and a management device which process a file by a workflow.

2. Description of the Related Art

There is a so-called workflow file, which is a file sequentially processed by a plurality of users, as disclosed in Japanese Laid-Open Patent Publication No. 2006-301742. That workflow file includes data defining the order of users who process, in addition to target data. The users access that data in the defined order to cause necessary processing to be executed. This processing is also called a workflow.

However, when executing such a workflow, a user needs to find out the order of processing previously, and needs to perform a manipulation for his/her own processing upon checking that a preceding user has terminated processing. This complicates the operation.

In the case where the processing is to be taken over from a preceding user to a subsequent user by a predetermined manipulation, it is necessary to find out the subsequent user who will take over the processing, and to perform an operation for indicating the subsequent user and taking over the processing. This also complicates the operation.

Further, when changing the order of processing of the workflow for some reason, it is usually necessary to change the above-mentioned data defining the order of users. Only a specific user, such as a user having predetermined authority (e.g., an administrator), can perform the processing for change. Therefore, a conventional workflow in which the order of processing has been defined previously does not meet the need for executing a series of operations of a workflow in a free order.

### SUMMARY OF THE INVENTION

The present invention was made in view of such problems, and has an object to provide a file processing system capable of executing a workflow of high usability, and a management device used for that file processing system.

To achieve the above-mentioned object, a file processing system according to an aspect of the present invention is a file processing system for processing a workflow file, including a plurality of file processing devices each having a touch panel for receiving input of a user operation. The workflow file includes body data and information defining a user who can process the workflow file. The file processing system further includes: an identifying unit for, when a first file processing device among the plurality of file processing devices to which a first user who can process the workflow file logs in detects that a first gesture of identifying the workflow file and a second gesture of indicating a second user who will process the workflow file subsequently have been performed on the touch panel, identifying the second user based on the second gesture and the defining information included in the workflow file; a reporting unit for reporting, to a second file processing device among the plurality of file processing devices corresponding to the second user, that identification as a user who will process the workflow file subsequently has been made by the identifying unit; and an acquisition unit for, when the second file processing device detects that a third gesture for making a request for processing of the workflow file has been performed, causing the second file processing device to acquire the body data of the workflow file in accordance with the request. The second gesture is a gesture of, continuously after at least one contact is made on the touch panel, moving the at least one contact toward an edge of the touch panel at a predetermined speed or higher, and then releasing the at least one contact at or near the edge of the touch panel. The identifying unit identifies the second user based on a direction in which the at least one contact is moved in the second gesture and the defining information included in the workflow file.

A file processing system according to another aspect of the present invention is a file processing system for processing a workflow file, including a plurality of file processing devices each having a touch panel for receiving input of a user operation. The workflow file includes body data and information defining an order of processing by users who can process the workflow file. The file processing system further includes: an identifying unit for, when a first file processing device among the plurality of file processing devices to which a first user who can process the workflow file logs in detects that a first gesture of identifying the workflow file has been performed, identifying a user subsequent to the first user in the order of processing in the defining information included in the workflow file, as the second user; a reporting unit for reporting, to a second file processing device among the plurality of file processing devices corresponding to the second user, that identification as a user who will process the workflow file subsequently has been made by the identifying unit; and an acquisition unit for, when the second file processing device detects that a third gesture for making a request for processing of the workflow file has been performed, causing the second file processing device to acquire the body data of the workflow file in accordance with the request.

A management device according to still another aspect of the present invention is a management device for managing processing of a workflow file in a file processing device, including a communication controller for controlling communications with a plurality of file processing devices. The workflow file includes body data and information defining a user who can process the workflow file. The management device further includes: an identifying unit for, when information indicative that a first gesture of identifying the workflow file and a second gesture of indicating a second user who will process the workflow file subsequently have been performed is received from a first file processing device among the plurality of file processing devices to which a first user who can process the workflow file logs in, identifying the second user based on the second gesture and the defining information included in the workflow file; a reporting unit for reporting, to a second file processing device among the plurality of file processing devices corresponding to the second user, that identification as a user who will process the workflow file subsequently has been made by the identifying unit; and a transmission unit for, when information indicative that a third gesture for making a request for processing of the workflow file is received from the second file processing device, transmitting the body data of the workflow file to the second file processing device in accordance with the request.

A management device according to still another aspect of the present invention is a management device for managing processing of a workflow file in a file processing device, including a communication controller for controlling communications with a plurality of file processing devices. The workflow file includes body data and information defining an order of processing by users who can process the workflow file. The management device further includes: an identifying unit for, when information indicative that a first gesture of identifying the workflow file has been performed is received from a first file processing device among the plurality of file processing devices to which a first user who can process the workflow file logs in, identifying a user subsequent to the first user in the order of processing in the defining information included in the workflow file, as the second user; a reporting unit for reporting, to a second file processing device among the plurality of file processing devices corresponding to the second user, that identification as a user who will process the workflow file subsequently has been made by the identifying unit; and a transmission unit for, when information indicative that a third gesture for making a request for processing of the workflow file is received from the second file processing device, transmitting the body data of the workflow file to the second file processing device in accordance with the request.

A control program according to still another aspect of the present invention is a program for controlling a management device to cause the management device to execute a process of managing processing of a workflow file in a plurality of file processing devices connected communicably with one another. The workflow file includes body data and information defining a user who can process the workflow file. The program causes the management device to execute the following steps of: when information indicative that a first gesture of identifying the workflow file and a second gesture of indicating a second user who will process the workflow file subsequently have been performed is received from a first file processing device among the plurality of file processing devices to which a first user who can process the workflow file logs in, identifying the second user based on the second gesture and the defining information included in the workflow file; reporting, to a second file processing device among the plurality of file processing devices corresponding to the second user, that identification as a user who will process the workflow file subsequently has been made in the step of identifying; and when information indicative that a third gesture for making a request for processing of the workflow file is received from the second file processing device, transmitting the body data of the workflow file to the second file processing device in accordance with the request.

A control program according to still another aspect of the present invention is a program for controlling a management device to cause the management device to execute a process of managing processing of a workflow file in a plurality of file processing devices connected communicably with one another. The workflow file includes body data and information defining an order of processing by users who can process the workflow file. The program causes the management device to execute the following steps of: when information indicative that a first gesture of identifying the workflow file has been performed is received from a first file processing device among the plurality of file processing devices to which a first user who can process the workflow file logs in, identifying a user subsequent to the first user in the order of processing in the defining information included in the workflow file, as a second user; reporting, to a second file processing device among the plurality of file processing devices corresponding to the second user, that identification as a user who will process the workflow file subsequently has been made in the step of identifying; and when information indicative that a third gesture for making a request for processing of the workflow file is received from the second file processing device, transmitting the body data of the workflow file to the second file processing device in accordance with the request.

A processing method according to still another aspect of the present invention is a processing method in a file processing system for processing a workflow file. The file processing system includes a plurality of file processing devices each having a touch panel for receiving input of a user operation and a management device capable of communicating with the plurality of file processing devices. The workflow file includes body data and information defining a user who can process the workflow file. The processing method includes the steps of: transmitting, from a first file processing device among the plurality of file processing devices to which a first user who can process the workflow file logs in to the management device, information indicative that a first gesture of identifying the workflow file and a second gesture of indicating a second user who will process the workflow file subsequently have been performed; in the management device, identifying the second user based on the second gesture and the defining information included in the workflow file; reporting, from the management device to a second file processing device among the plurality of file processing devices corresponding to the second user, that identification as a user who will process the workflow file subsequently has been made in the step of identifying; and when information indicative that a third gesture for making a request for processing of the workflow file is received from the second file processing device, transmitting the body data of the workflow file from the management device to the second file processing device.

A processing method according to still another aspect of the present invention is a processing method in a file processing system for processing a workflow file. The file processing system includes a plurality of file processing devices each having a touch panel for receiving input of a user operation and a management device capable of communicating with the plurality of file processing devices. The workflow file includes body data and information defining an order of processing by users who can process the workflow file. The processing method includes the steps of: transmitting, from a first file processing device among the plurality of file processing devices to which a first user who can process the workflow file logs in to the management device, information indicative that a first gesture of identifying the workflow file has been performed; in the management device, identifying a user subsequent to the first user in the order of processing in the defining information included in the workflow file, as a second user; reporting, from the management device to a second file processing device among the plurality of file processing devices corresponding to the second user, that identification as a user who will process the workflow file subsequently has been made in the step of identifying; and when information indicative that a third gesture for making a request for processing of the workflow file is received from the second file processing device, transmitting the body data of the workflow file from the management device to the second file processing device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of a file processing system according to an embodiment.

FIG. 2 shows a specific example of a hardware configuration of a management device, which is MFP (Multi-Functional Peripheral), included in the file processing system according to the embodiment.

FIG. 3 shows a specific example of a hardware configuration of a file processing device, which is a portable terminal, included in the file processing system according to the embodiment.

FIG. 4 shows the outline of an operation for file processing in a file processing system according to a first embodiment.

FIG. 5 illustrates a pinch-in gesture.

FIG. 6 illustrates a pinch-out gesture.

FIG. 7 illustrates a fly gesture.

FIG. 8 is a diagram showing a specific example of a functional configuration of a file processing device for achieving operations in the file processing system according to the first embodiment.

FIGS. 9 to 13 each illustrate a specific example of a method of identifying an icon subjected to the pinch-in gesture.

FIG. 14 is a diagram showing a specific example of a functional configuration of the management device for achieving operations in the file processing system according to the first embodiment.

FIG. 15 is a flow chart showing a specific example of an operation in the management device according to the first embodiment.

FIG. 16 is a block diagram showing a specific example of a functional configuration of a management device according to a variation of the first embodiment.

FIG. 17 shows a specific example of a selection screen presenting users available as a target of delegation.

FIG. 18 shows the outline of an operation for file processing in a file processing system according to a second embodiment.

FIG. 19 is a flow chart showing a specific example of an operation in a management device according to the second embodiment.

### DESCRIPTION OF THE PREFERRED EMBODIMENTS

Hereinafter, embodiments of the present invention will be described with reference to the drawings. In the following description, like parts and components are denoted by like reference characters. They are named and function identically as well.

<System Configuration>

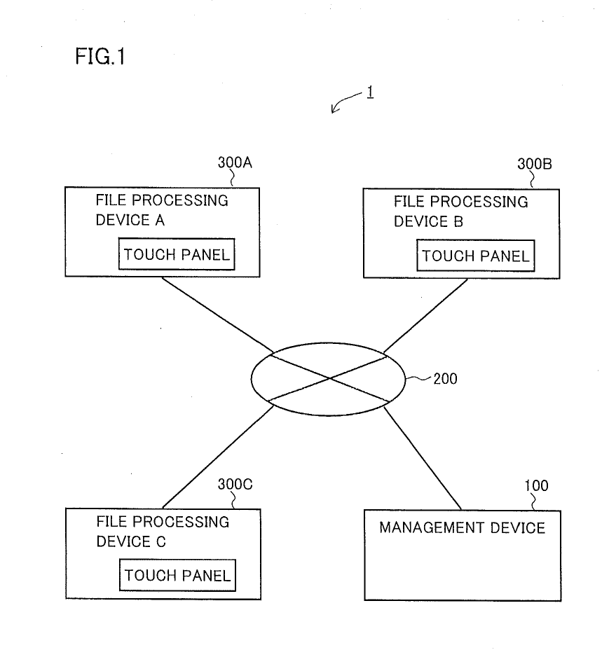

FIG. 1 shows a specific example of a configuration of a file processing system 1 according to the present embodiment.

Referring to FIG. 1, file processing system 1 according to the present embodiment includes a management device 100 and a plurality of file processing devices 300A, 300B, and 300C, (representatively referred to as a file processing device 300), connected through a network 200, such as LAN (Local Area Network) or the Internet.

Management device 100 is a device that functions as a server, and may be implemented by a typical personal computer or by an image forming apparatus, such as MFP (Multi-Functional Peripheral). One of file processing devices 300 may function as management device 100. The present example will be described assuming that management device 100 is implemented by MFP.

File processing device 300 may be any device as long as it has a function for processing a file and a communication function. That is, it may be implemented by a typical personal computer or by a portable terminal, such as a mobile phone. The present example will be described assuming that file processing device 300 is implemented by a portable terminal, such as a mobile phone, and that the portable terminal has a touch panel as an operation unit.

<Device Configuration of Management Device>

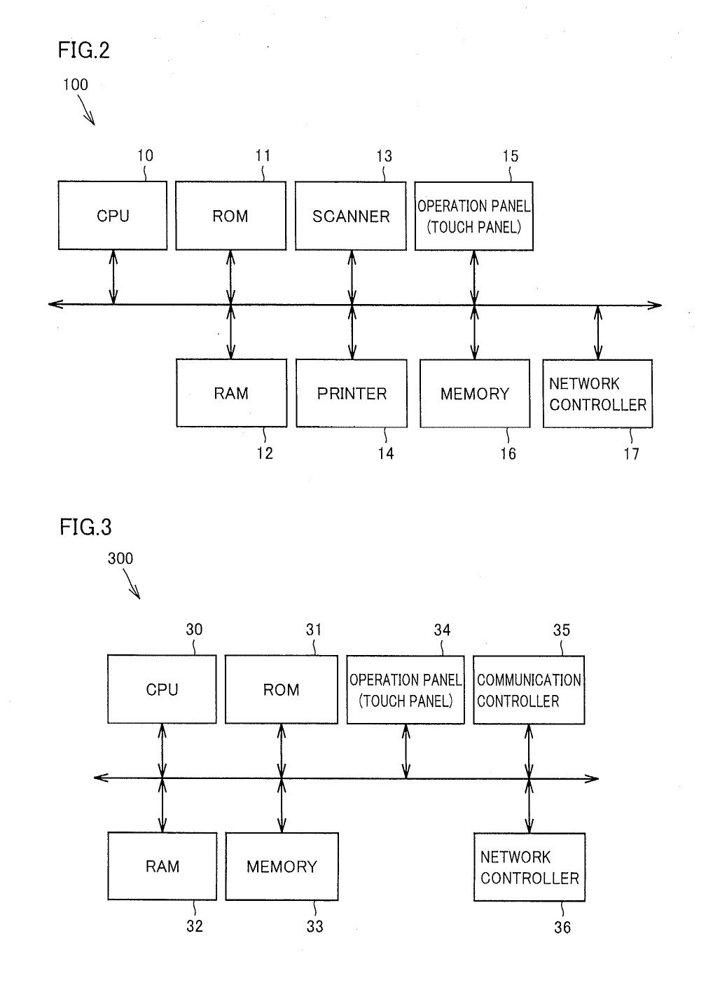

FIG. 2 shows a specific example of a hardware configuration of management device 100 which is MFP.

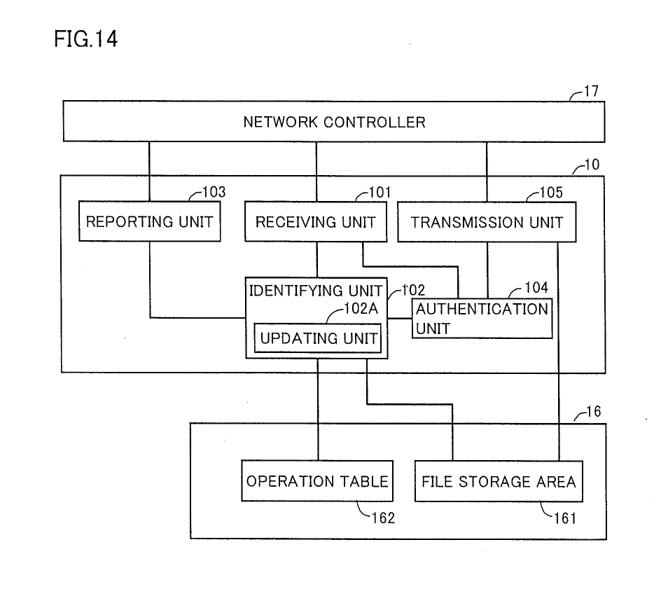

Referring to FIG. 2, management device 100 which is MFP includes a CPU (Central Processing Unit) 10 as an arithmetic device for overall control, a ROM (Read Only Memory) 11 for storing programs and the like to be executed by CPU 10, a RAM (Random Access Memory) 12 for functioning as a working area during execution of a program by CPU 10, a scanner 13 for optically reading a document placed on a document table not shown to obtain image data, a printer 14 for fixing image data on a printing paper, an operation panel 15 including a touch panel for displaying information and receiving an operation input to management device 100 concerned, a memory 16 for storing information and/or programs including a file storage area 161 (cf. FIG. 14) for storing a file of image data and the like, and a network controller 17 for controlling communications through network 200.

Operation panel 15 includes the touch panel and an operation key group not shown. The touch panel is composed of a display device such as a liquid crystal display and a pointing device such as an optical touch panel or a capacitance touch panel, the display device and the pointing device overlapping each other, and displays an operation screen so that an indicated position on the operation screen is identified. CPU 10 causes the touch panel to display the operation screen based on data stored previously for causing screen display.

The indicated position (position of touch) on the touch panel as identified and an operation signal indicating a pressed key are input to CPU 10. CPU 10 identifies details of manipulation based on the pressed key or the operation screen being displayed and the indicated position, and executes a process based thereon.

It is noted that although in the present example, management device 100 which is MFP shall have operation panel 15 which is a touch panel as an operation unit and a display unit, the configuration of the operation unit and the display unit is not limited to this configuration, but may be a typical key and display.

<Configuration of File Processing Device>

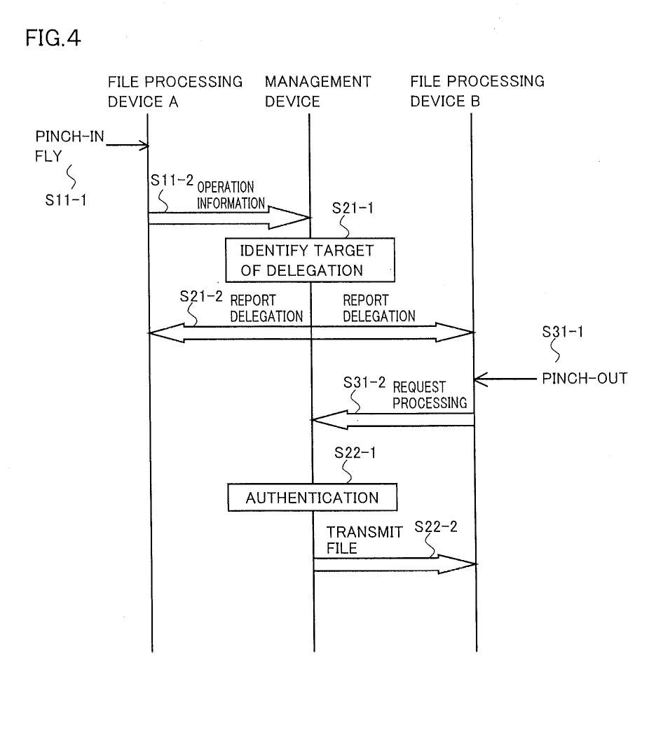

FIG. 3 shows a specific example of a hardware configuration of file processing device 300 which is a portable terminal.

Referring to FIG. 3, file processing device 300 includes a CPU 30 as an arithmetic device for overall control, a ROM 31 for storing programs and the like to be executed by CPU 30, a RAM 32 for functioning as a working area during execution of a program by CPU 30, a memory 33 for storing a file and the like, an operation panel 34 including a touch panel for displaying information and receiving an operation input to file processing device 300 concerned, a communication controller 35 for controlling communications through telephone lines by communicating with a base station not shown, and a network controller 36 for controlling communications through network 200.

Operation panel 34 may have a configuration similar to that of operation panel 15 of management device 100. That is, as an example, operation panel 34 includes a touch panel composed of a display device such as a liquid crystal display and a pointing device such as an optical touch panel or a capacitance touch panel, the display device and the pointing device overlapping each other.

CPU 30 causes the touch panel to display an operation screen based on data stored previously for causing screen display. On the touch panel, the indicated position on the operation screen is identified, and an operation signal indicating that position is input to CPU 30. CPU 30 identifies details of manipulation based on the operation screen being displayed and the indicated position, and executes a process based thereon.

### First Embodiment

<Outline of Operations>

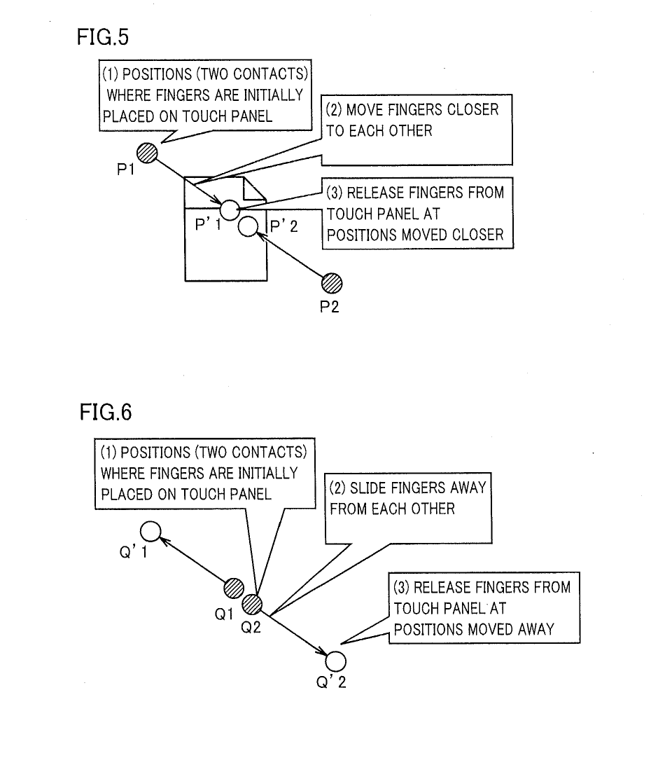

FIG. 4 shows the outline of an operation for file processing in file processing system 1 according to the first embodiment.

As a precondition, management device 100 according to the first embodiment has a file for workflow processing (hereinafter referred to as a workflow file) stored in file storage area 161 of memory 16. The workflow file includes a file body and information defining users who can process that file (hereinafter referred to as defining information).

Memory 16 has stored therein an operation table 162 in which correspondence between the direction indicated by a “fly gesture” as a third gesture to be described later and a user is stored. Operation table 162 may be stored previously, or may be created and/or updated by a specific user operation.

A user accesses management device 100 using file processing device 300 to which he/she has logged in, and when authentication in management device 100 succeeds, the user can receive body data of the workflow file from management device 100 and perform necessary processing. In the description below, a state in which a workflow file is processable for a user will be called “a state having authority”, and a state in which the processable state is transferred to a subsequent user will be defined as “delegate authority.”

Referring to FIG. 4, in file processing device 300A (a file processing device A in the drawing) to which a user having authority to process a workflow file has logged in and which is being operated by the user, the user performs a first gesture on an icon presenting the workflow file for instructing termination of processing of the workflow, and then performs a second gesture for indicating a target of delegation of authority.

The first and second gestures are not limited to specific gestures as long as they can be made on operation panel 34 which is a touch panel. In the present example, however, the first gesture shall be a “pinch-in gesture” and the second gesture shall be a “fly gesture”, as a suitable example. The details of gestures will be described later.

When the user performs these gestures (Step S11-1), a direction indicated by the “fly gesture” is identified, and the body data and the direction indicated by the “fly gesture” is transmitted to management device 100 as operation information (Step S11-2).

Management device 100, upon receipt of the information, updates body data of the workflow file stored in file storage area 161 with the received body data. The login user of file processing device 300A updates the defining information included in the workflow file as having been processed.

Management device 100 identifies a user indicated by the user of file processing device 300A to whom authority is to be delegated, based on the direction indicated by the “fly gesture” included in the received operation information and the defining information included in the workflow file. Then, the identified user targeted for delegation is reported to file processing device 300A, while file processing device 300B to which the user targeted for delegation previously stored has logged in (a file processing device B in the drawing) (or file processing device 300B previously stored in correspondence with that user) is informed of having been determined as the target of delegation (Step S21-2).

The user targeted for delegation logs in to file processing device 300B and performs the third gesture for requesting processing of the workflow file on operation panel 34. The third gesture is not limited to a specific gesture as long as it can be made on operation panel 34 which is a touch panel. In the present example, however, it shall be a “pinch-out gesture” as a suitable example. The details of gesture will be described later.

When the user performs such a gesture (Step S31-1), a request for processing the workflow file is transmitted from file processing device 300B to management device 100 (Step S32-2).

In management device 100, upon receipt of the processing request from file processing device 300B, conducts authentication whether or not the login user is the user targeted for delegation using information that identifies the login user of file processing device 300B (Step S22-1), and when the authentication succeeds, transmits body data of the workflow file to file processing device 300B (Step S22-2). The user is thereby allowed to process the workflow file in file processing device 300B.

<Description of Gesture>

Here, the “pinch-in gesture”, the “pinch-out gesture” and the “fly gesture” will be described.

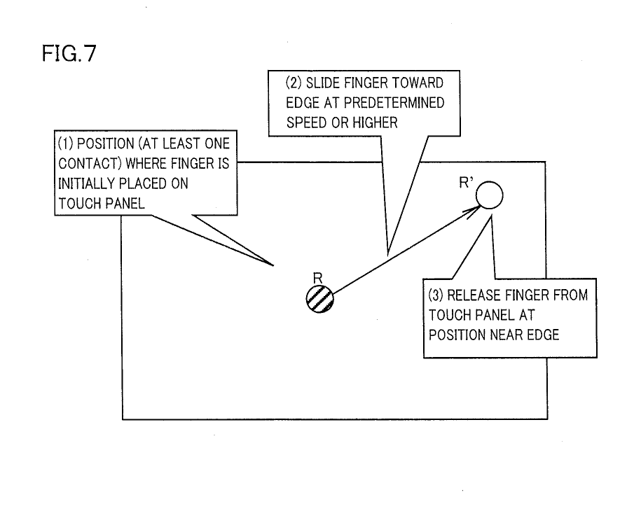

FIG. 5 illustrates a “pinch-in (pinch-close)” gesture. Referring to FIG. 5, the “pinch-in” or pinching gesture refers to a motion of making two contacts P1 and P2 on the touch panel using, for example, two fingers or the like, and then moving the fingers closer to each other from their initial positions linearly or substantially linearly, and releasing the two fingers from the touch panel at two contacts P′1 and P′2 moved closer. That is, the “pinch-in gesture” refers to a motion of, continuously after two contacts are made on the touch panel, moving the two contacts in the direction that the spacing therebetween is decreased and then releasing the two contacts after being moved.

When it is detected that two contacts P1 and P2 on the touch panel have been made simultaneously, and further, the respective contacts have been continuously displaced from their initial positions linearly or substantially linearly, and both the contacts have been released almost simultaneously at two contacts P′1 and P′2 positioned at a spacing narrower than the spacing between their initial positions, CPU 10 detects that the “pinch-in” gesture has been performed.

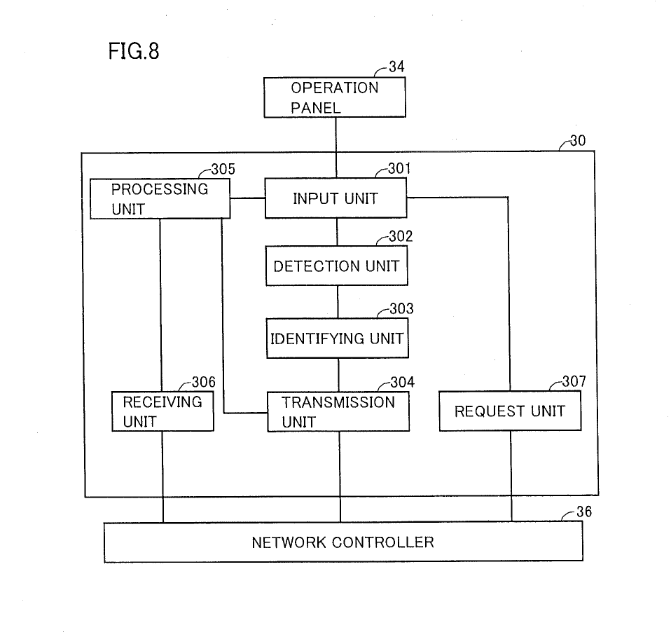

FIG. 6 illustrates a “pinch-out (pinch-open)” gesture. Referring to FIG. 6, the “pinch-out” or anti-pinching gesture refers to a motion of making two contacts Q1 and Q2 on the touch panel using, for example, two fingers or the like, and then moving the fingers away from their initial positions linearly or substantially linearly, and releasing the two fingers from the touch panel at two contacts Q′1 and Q′2 moved away to some degree. That is, the “pinch-out gesture” refers to a motion of, continuously after two contacts are made on the touch panel, moving the two contacts in the direction that the spacing therebetween is increased and then releasing the two contacts after being moved.

When it is detected that two contacts Q1 and Q2 on the touch panel have been made simultaneously, and further, the respective contacts have been continuously displaced from their initial positions linearly or substantially linearly, and both the contacts have been released almost simultaneously at two contacts Q′1 and Q′2 positioned at a spacing wider than the spacing between their initial positions, CPU detects that the “pinch-out” or de-pinching gesture has been performed.

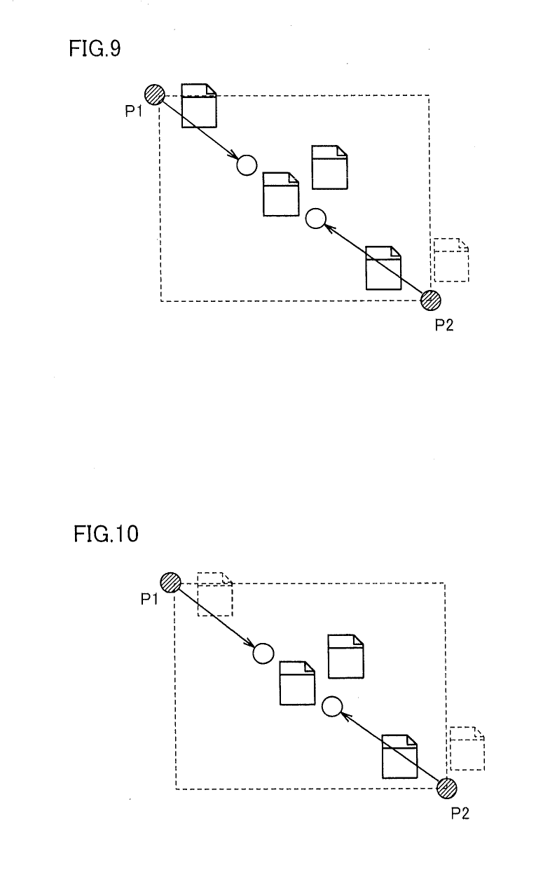

FIG. 7 illustrates the “fly gesture.” Referring to FIG. 7, the “fly gesture” refers to a motion of indicating at least one point R on the touch panel using, for example, one finger or the like, and then sliding the finger from that position linearly or substantially linearly toward the edge of the touch panel at a predetermined speed or higher and releasing the finger from the touch panel at a point R′ near the edge of the touch panel. More specifically, the “fly gesture” refers to a motion of, continuously after at least one contact is made on the touch panel, moving the contact toward the edge of the touch panel at a predetermined speed or higher, and then releasing the contact at or near the edge of the touch panel.

When it is detected that point R on the touch panel has been indicated and the contact has been displaced continuously from that position linearly or substantially linearly toward the edge of the touch panel at a predetermined speed or higher, and then the contact has been released at point R′ near the edge of the touch panel, CPU detects that the fly gesture has been performed.

<Functional Configuration>

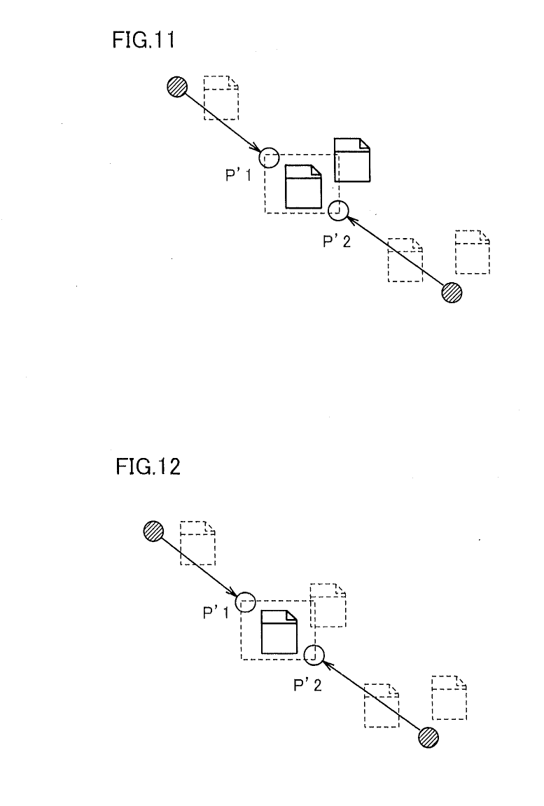

FIG. 8 is a diagram showing a specific example of a functional configuration of file processing device 300 for achieving the above-described operations in file processing system 1 according to the first embodiment. Each function shown in FIG. 8 is a function mainly configured in CPU 30 by CPU 30 reading a program stored in ROM 31 and executing the program on RAM 32. However, at least some functions may be configured by the hardware configuration shown in FIG. 3.

Referring to FIG. 8, as functions for achieving the above-described operations, file processing device 300 includes an input unit 301 for receiving input of an operation signal indicating an instruction on operation panel 34, a detection unit 302 for detecting the above-described gestures based on the operation signal, a processing unit 305 for executing processing of a workflow file based on the operation signal indicating typical instructions on operation panel 34, an identifying unit 303 for, when the pinch-in gesture and the fly gesture are made, identifying an icon subjected to the pinch-in gesture to identify a target workflow file while identifying the direction indicated by the fly gesture, a transmission unit 304 having management device 100 previously stored therein as a destination, and when the pinch-in gesture and the fly gesture are made, transmitting the direction indicated by the fly gesture and body data of the workflow file having been processed in processing unit 305 as operation information to management device 100 through network controller 36, a receiving unit 306 for receiving the body data of the workflow file from management device 100 through network controller 36, and a request unit 307 having management device 100 previously stored therein as a requester, and when the pinch-out gesture is made, sending a request for processing the workflow to management device 100 through network controller 36.

As an example, CPU 10 of file processing device 300A identifies an icon, displayed in an area defined based on at least either two contacts (two contacts P1, P2 in FIG. 5) indicated initially in the pinch-in gesture or two contacts (two contacts P′1, P′2 in FIG. 5) indicated finally, as an icon subjected to the pinch-in gesture.

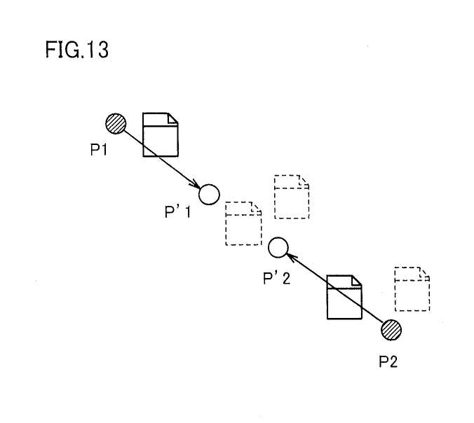

The method of identifying an icon subjected to the pinch-in gesture in identifying unit 303 is not limited to a certain method. FIGS. 9 to 13 each illustrate a specific example of a method of identifying an icon subjected to the pinch-in gesture in identifying unit 303.

As an example, as shown in FIG. 9, identifying unit 303 may identify a rectangle in which two contacts P1 and P2 indicated initially are at opposite corners as an area defined by the pinch-in gesture, and may identify icons, each of which is at least partially included in that rectangle, may be identified as target icons. Alternatively, as shown in FIG. 10, a rectangle in which two contacts P1 and P2 indicated initially are at opposite corners may be identified as an area defined by the pinch-in gesture, and icons completely included in that rectangle may be identified as target icons. With such identification, the user touches operation panel 34 with two fingers so as to sandwich an intended icon, and performs a motion for the pinch-in gesture from that state, so that the intended icon can thus be a target of processing in an intuitive manner. Even when an icon image is small, it can be indicated correctly.

As another example, as shown in FIG. 11, identifying unit 303 may identify a rectangle in which two contacts P′1 and P′2 indicated finally are at opposite corners as an area defined by the pinch-in gesture, and may identify icons, each of which is at least partially included in that rectangle, may be identified as target icons. Alternatively, as shown in FIG. 12, a rectangle in which two contacts P′1 and P′2 indicated finally are at opposite corners may be identified as an area defined by the pinch-in gesture, and an icon completely included in that rectangle may be identified as a target icon. With such identification, the user touches operation panel 34 with two fingers spaced apart, and then moves them closer to each other so that an intended icon is sandwiched finally between the two fingers. The intended icon can thus be a target of processing in an intuitive manner. Even when an icon image is small, it can be indicated correctly.

As still another example, as shown in FIG. 13, identifying unit 303 may identify two lines that connect two contacts P1, P2 indicated initially and two contacts P′1, P′2 indicated finally, respectively, as areas defined by the pinch-in gesture, and may identify icons where either one line overlaps as target icons. With such identification, the user moves the two fingers so as to pinch in an intended icon, so that the intended icon can thus be a target of processing in an intuitive manner. The file to be transferred can thus be a target of processing in an intuitive manner. Even when an icon image is small, it can be indicated correctly.

The method of identifying the direction indicated by the fly gesture in identifying unit 303 is not limited to a certain method. As an example, the angle formed by an initially indicated point (R in FIG. 7) and a point where the contact is released (R′ in FIG. 7) may be identified as the direction indicated by the fly gesture. As another example, an edge of operation panel 34 closest to the point where the contact is released (R′ in FIG. 7) may be identified for the direction indicated by the fly gesture.

FIG. 14 is a diagram showing a specific example of a functional configuration of management device 100 for achieving the above-described operations in file processing system 1 according to the first embodiment. Each function shown in FIG. 14 is a function mainly configured in CPU 10 by CPU 10 reading a program stored in ROM 11 and executing the program on RAM 12. However, at least some functions may be configured by the hardware configuration shown in FIG. 2.

Referring to FIG. 14, as functions for achieving the above-described operations, management device 100 includes a receiving unit 101 for receiving information transmitted from file processing device 300 through a network controller 17, an identifying unit 102 for, when the received information is the above-described operation information, using body data of a workflow file included therein to update body data of that workflow file stored in file storage area 161, while identifying a user included in the received information corresponding to the direction indicated by the fly gesture referring to operation table 162, a reporting unit 103 for reporting an identified target of delegation to file processing device 300 having received the operation information and file processing device 300 to which the user targeted for delegation has logged in (or previously stored in association with the user targeted for delegation) through network controller 17, an authentication unit 104 for, when the received information requests processing of the workflow file, conducting authentication whether or not the login user of file processing device 300 having transmitted that request is the user identified by identifying unit 102, and a transmission unit 105 for transmitting the body data of the workflow file to the user targeted for delegation through network controller 17 when the authentication succeeds.

Further, identifying unit 102 preferably includes an updating unit 102A for updating defining information of the file included in the workflow file based on information that identifies the user having performed the pinch-in gesture included in the above-described operation information. That the user has already performed processing for the workflow file will thereby be written in this information.

Preferably, identifying unit 102 identifies a user corresponding to the direction indicated by the fly gesture referring to operation table 162, and then referring to the defining information of the file included in the workflow file, determines whether or not the identified user has already performed processing for the workflow file. When it is determined that the user has not performed processing yet, the identified user is determined as a user targeted for delegation.

It is noted that, when it is determined that the user has already processed the workflow file, an error may be returned to file processing device 300A. Alternatively, a user who has not performed processing yet may be identified referring to the defining information of the file, and the user may be reported to file processing device 300A.

Authentication unit 104 stores the user targeted for delegation identified by identifying unit 102, and when the information that requests processing of the workflow file is received from file processing device 300B, conducts authentication whether or not the user is the user targeted for delegation using the information that identifies the login user of file processing device 300B included in that information. At that time, authentication unit 104 preferably stores the target of delegation in association with information that identifies the workflow. Then, targets of delegation can be stored for each of a plurality of workflows.

<Flow of Operation>

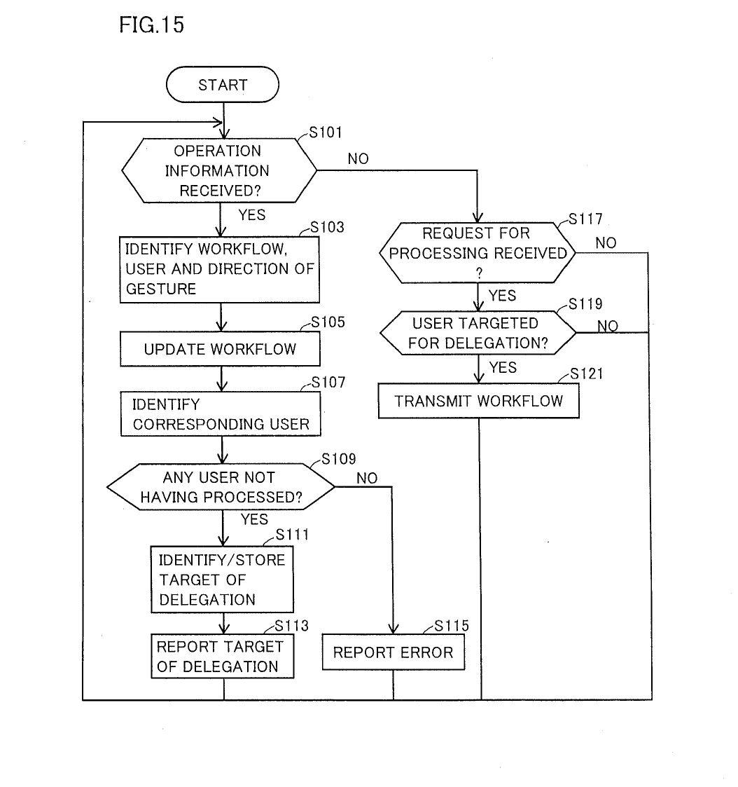

FIG. 15 is a flow chart showing a specific example of an operation in management device 100 according to the first embodiment. The operation shown in the flow chart of FIG. 15 is implemented by CPU 10 reading a program stored in ROM 11, executing the program on RAM 12, and causing the respective functions shown in FIG. 14 to be effected.

Referring to FIG. 15, when operation information in accordance with the pinch-in gesture and the fly gesture is received from file processing device 300A (YES in Step S101), CPU 10 in Step S103 identifies a target workflow file, a user having performed the gestures, and the direction indicated by the fly gesture having been performed in file processing device 300A based on the received operation information. Then, in Step S105, CPU 10 updates the body data of the workflow file stored in file storage area 161 using the body data included in the received operation information, while updating the defining information of the workflow file assuming that the user having performed the above-described gestures has processed the workflow file.

In Step S107, CPU 10 identifies a user corresponding to the direction indicated by the fly gesture referring to operation table 162 of memory 16. In the case where the user is a user who has not yet processed the workflow file referring to the defining information of the workflow file, CPU 10 in Step S111 identifies the identified user as a target of delegation, and stores the user temporarily. Then, in Step S113, CPU 10 reports to file processing device 300A and file processing device 300B to which the user identified in Step S111 has logged in (or which is stored previously in association with the user) that the user has been identified as a target of delegation. It is noted that, at that time, the user identified in above-described step S103 having previously processed the workflow file may also be reported to file processing device 300B. Then, the user targeted for delegation can find out from which user the authority to process the workflow file has been delegated, and can omit this user when identifying a user targeted for delegation subsequently.

It is noted that, in the case where the user corresponding to the direction indicated by the fly gesture identified in above-described Step S107 has already processed the workflow file (YES in Step S109), CPU 10 in Step S115 reports an error to file processing device 300A. At this time, a user who has not yet processed may be identified referring to the defining information of the workflow file, and an error may be reported together with information that identifies this user. Then, the user having performed processing previously can select a user to be targeted for delegation from among users who have not yet performed processing.

A series of operations when operation information is received is then terminated, and the process is returned to the beginning, where receipt of information from file processing device 300 is waited for.

When information that requests processing of a workflow in accordance with the pinch-out gesture is received from file processing device 300B (NO in Step S101 and YES in Step S117), CPU 10 conducts authentication whether or not a login user of file processing device 300 having made that request matches the user identified in above-described Step S111 as the target of delegation. As a result, when a match with the user identified as the target of delegation occurs (YES in Step S119), CPU 10 in Step S121 transmits the body data of the workflow to file processing device 300B.

A series of operations when operation information is received is then terminated, and the process is returned to the beginning, where receipt of information from file processing device 300 is waited for.

It is noted that the flow chart of FIG. 15 shows that, when the user having requested processing of the workflow file does not match the user identified as the target of delegation (NO in Step S119), Step S121 is skipped to return the process to the beginning. As another example, an error may be reported to file processing device 300B. When this user is not a user targeted for delegation but a user who has not yet performed the workflow file, a report may be sent to file processing device 300A to check whether or not the authority to process the workflow file is delegated to that user.

When a request for processing of the workflow file is not made within a prescribed time (e.g., one day, etc.) from the user targeted for delegation identified in above-described Step S111, a report may be sent again to the user targeted for delegation, or an error may be reported to file processing device 300A.

### Effects of Embodiment

With the above-described operations being performed in file processing system 1 according to the first embodiment, the user having processed the workflow file can easily delegate the authority to another user without checking users defined as being able to process that workflow file.

By adopting the pinch-in gesture, the fly gesture and the pinch-out gesture as gestures performed at this time, users can exchange the authority of the workflow file with intuitive and easy manipulations.

Further, the workflow file according to the first embodiment merely defines users who can perform processing, and the order of processing is not defined. Then, when a user indicated as a subsequent user is determined in management device 100 as a user who has not yet processed the workflow file, the indicated user is identified as a target of delegation, i.e., a user who performs processing subsequently. Therefore, users who process the workflow file can perform processing in a free order of processing, without being restricted to a defined order of processing, and indication can be performed by each user in a simple manner. Accordingly, flexibility in processing a workflow file increases, which improves user-friendliness.

It is noted that, in the above description, the workflow file shall be stored in management device 100, and each file processing device 300 shall access management device 100 to process that workflow file. However, as another example, a method may be adopted in which a workflow file itself is transferred among respective file processing devices 300. This also applies to a second embodiment which will be described later.

In this case, management device 100 may hold defining information of the workflow file, or may access file processing device 300 holding the workflow file to read defining information. Then, in above-described step S113, the target of delegation may be reported to file processing device 300A, while a command instructing transmission of the workflow file may be transmitted to file processing device 300B corresponding to the user targeted for delegation (to which the user has logged in or which is previously stored in association with that user).

<Variation 1>

In the above-described example, management device 100 shall previously store operation table 162 defining correspondence between the direction indicated by the fly gesture and a user, and shall identify the user indicated by the fly gesture referring to operation table 162.

However, the method of identifying the user indicated by the fly gesture is not limited to this method. As another example, management device 100 may identify the user indicated by the fly gesture depending on the actual position of file processing device 300.

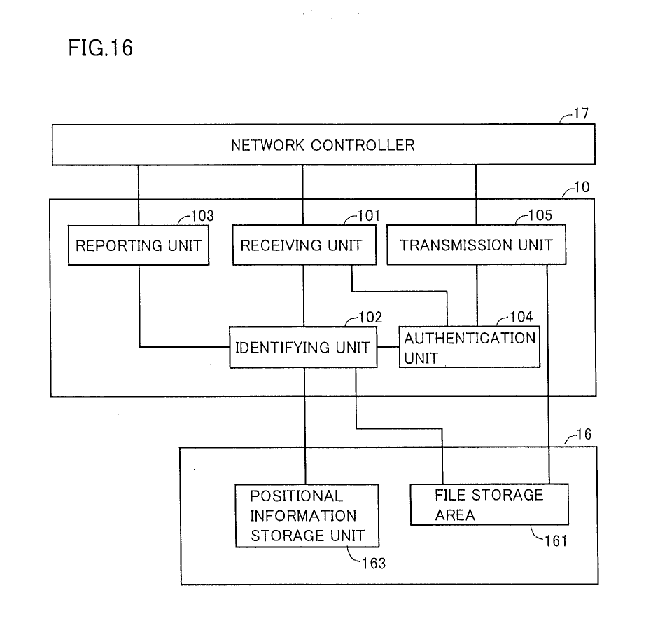

FIG. 16 is a block diagram showing a specific example of a functional configuration of management device 100 according to a variation of the first embodiment. Referring to FIG. 16, in order to identify the user indicated by the fly gesture as described above, management device 100 has stored therein a positional information storage unit 163 for previously storing positional information on each file processing device 300, instead of operation table 162. The positional information on each file processing device 300 may be input by a specific user, such as an administrator, or when each file processing device 300 has a function of acquiring its own positional information by GPS (Global Positioning System), may be acquired by requesting positional information from each file processing device 300 or necessary file processing device 300 at a timing when communication has been established through network 200, at a predetermined time interval, at a timing when the above-described operation information has been received, or the like.

In this case, when the fly gesture has been made, file processing device 300A identifies in which direction relative to itself that gesture has been made, and transmits the information to management device 100 as operation information.

CPU 10 of management device 100 in above-described Step S103 identifies the direction indicated by the fly gesture based on information showing in which direction from file processing device 300A the fly gesture included in the operation information has been made and the positional information on that file processing device 300A. Then, in above-described Step S107, the direction from the position of file processing device 300A to the position of each file processing device 300 is compared with the identified direction, thereby identifying corresponding file processing device 300B. Thereafter, an operation similar to that shown in FIG. 15 will be performed.

With file processing system 1 configured in this manner, a user can delegate authority to a subsequent user by intuitively making a fly gesture toward file processing device 300 corresponding to the subsequent user, without finding out the correspondence between the direction indicated by the fly gesture and the user.

<Variation 2>

It is noted that, although in the above examples and the first variation, the user targeted for delegation shall be indicated by the fly gesture, the fly gesture is merely an example of the second gesture as described above, and is not limited to such a gesture.

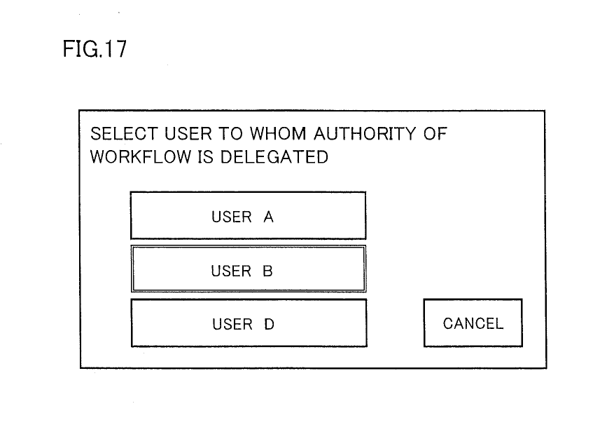

As another example, by performing the first gesture described as the pinch-in gesture in the above examples to report from file processing device 300A to management device 100 that the authority over the workflow file is delegated to another user, a user to whom the authority can be delegated may be extracted in management device 100 based on the defining information of the workflow file and may be reported to file processing device 300A. In this case, a selection screen presenting users (or file processing devices) available as targets of delegation as shown in FIG. 17 may be displayed on operation panel 34, and a target of delegation may be indicated from among them by receiving selection made by touching or the like, and information thereof may be transmitted from file processing device 300A to management device 100 as operation information. Thereafter, an operation similar to that shown in FIG. 15 will be performed.

Also with file processing system 1 configured in this manner, a user can easily indicate a subsequent user, without finding out a user defined as being able to process the workflow file subsequently.

### Second Embodiment

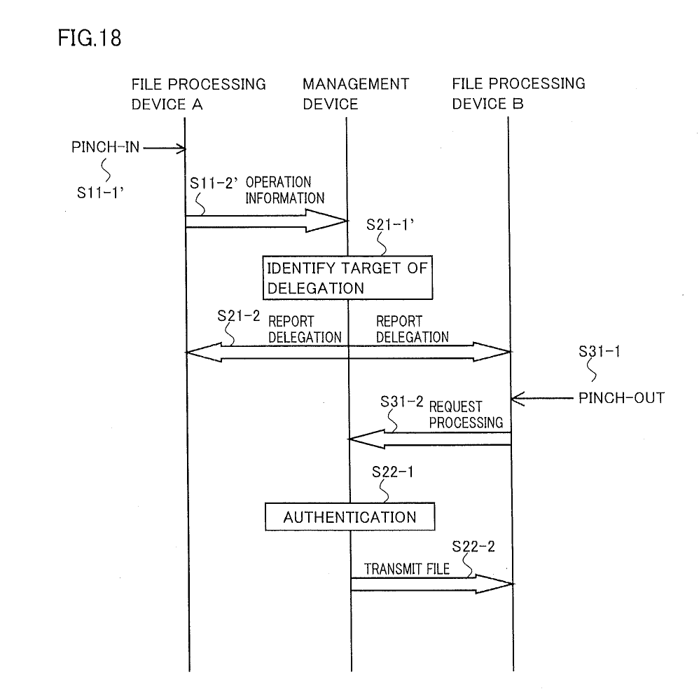

FIG. 18 shows the outline of an operation for file processing in file processing system 1 according to a second embodiment.

As a precondition, in the second embodiment, defining information included in a workflow file defines the order of processing of a workflow file, which is stored in file storage area 161 of memory 16 of management device 100.

Referring to FIG. 18, in file processing system 1 according to the second embodiment, a user having authority to process the workflow file performs the pinch-in gesture which is the first gesture for indicating termination of processing of the workflow on an icon presenting the workflow file in file processing device 300A (Step S11-1′), so that the body data and that the pinch-in gesture has been executed are transmitted to management device 100 as operation information (step S11-2′).

Upon receipt of the information, management device 100 updates the body data of the workflow file stored in file storage area 161 with the received body data, while identifying the user defined as a user who will process the workflow file subsequently to the user who is operating file processing device 300A as a user targeted for delegation, referring to the defining information (step S12-1′). Thereafter, an operation similar to that of file processing system 1 according to the first embodiment will be performed. That is, a report is sent to file processing device 300A and file processing device 300B corresponding to the user targeted for delegation. Then, upon receipt of a request for processing from the user targeted for delegation, the body data of the workflow file will be transmitted to file processing device 300B.

<Functional Configuration>

The functional configurations of file processing device 300 and management device 100 according to the second embodiment are generally similar to the functional configurations according to the first embodiment shown in FIGS. 8 and 14, respectively. However, identifying unit 102 of management device 100 differs from identifying unit 102 of management device 100 according to the first embodiment in that it identifies a user defined as processing a workflow file subsequently to a user having made the pinch-in gesture, referring to defining information that defines the order of processing of the workflow file identified by operation information.

<Flow of Operation>

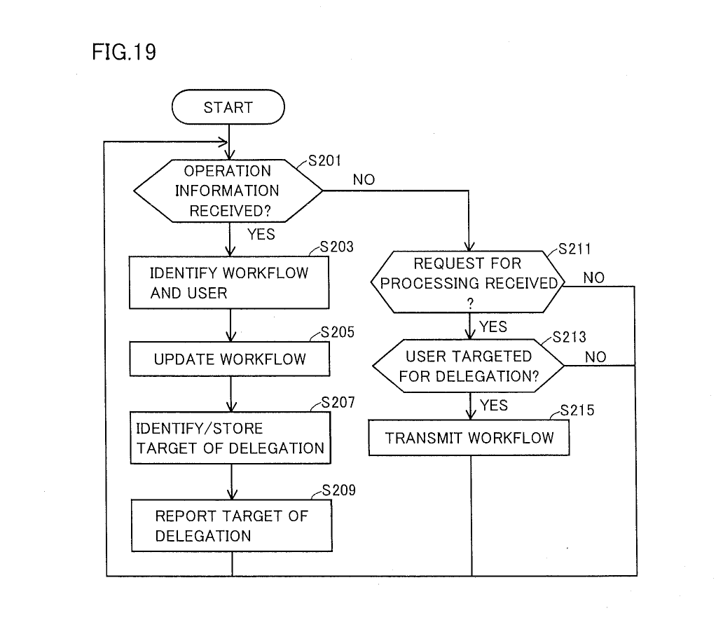

FIG. 19 is a flow chart showing a specific example of an operation in management device 100 according to the second embodiment. The operation shown in the flow chart of FIG. 19 is implemented by CPU 10 reading a program stored in ROM 11, executing the program on RAM 12, and causing the respective functions shown in FIG. 14 to be effected.

Referring to FIG. 19, upon receipt of operation information in accordance with the pinch-in gesture from file processing device 300A (YES in Step S201), CPU 10 in Step S203 identifies a target workflow file and a user having performed that gesture based on the received operation information. Then, in Step S205, CPU 10 updates the body data of the workflow file stored in file storage area 161 with the body data included in the received operation information, while updating the defining information of the workflow file assuming that the user having performed the above-described gesture has processed the workflow file.

In Step S207, CPU 10 identifies a user defined as the user who will process the workflow file subsequently to the user identified in above-described Step S203 referring to the defining information of the workflow file, and identifies the user as a user targeted for delegation and stores the user temporarily. Then, in Step S209, CPU 10 reports to file processing device 300A and file processing device 300B corresponding to the user identified in Step S207 (to which the user has logged in or which is stored previously in association with that user) that the user has been identified as the target of delegation.

A series of operations when operation information is received is then terminated, and the process is returned to the beginning, where receipt of information from file processing device 300 is waited for.

Upon receipt of information that requests processing of the workflow in accordance with the pinch-out gesture from file processing device 300B (NO in Step S201 and YES in Step S211), CPU 10 conducts authentication whether or not the login user of file processing device 300B having made that request matches the user identified as the target of delegation in above-described Step S207. As a result, when a match with the user identified as the target of delegation occurs (YES in Step S213), CPU 10 in Step S215 transmits the body data of the workflow to file processing device 300B.

A series of operations when operation information is received is then terminated, and the process is returned to the beginning, where receipt of information from file processing device 300 is waited for.

It is noted that this example also shows that, when the user having requested processing of the workflow file does not match the user identified as the target of delegation (NO in Step S213), Step S215 is skipped to return the process to the beginning. As another example, an error may be reported to file processing device 300B.

When a request for processing of the workflow file is not made within a prescribed time (e.g., one day, etc.) from the user targeted for delegation identified in above-described Step S207, a report may be sent again to the user targeted for delegation, or an error may be reported to file processing device 300A.

### Effects of Embodiment

With the above-described operations being performed in file processing system 1 according to the second embodiment, a user having processed a workflow file, even if it defines the order of processing, can easily delegate authority to a subsequent user without finding out a user who will perform processing subsequently.

### Other Examples

Further, a program for causing management device 100 to perform the above-described operations can also be offered. Such a program can be recorded on a computer-readable recording medium, such as a flexible disk attached to a computer, a CD-ROM (Compact Disk-Read Only Memory), a ROM, a RAM, a memory card, or the like, and can be offered as a program product. Alternatively, a program can be offered as recorded on a recording medium such as a hard disk built in a computer. Still alternatively, the program can also be offered by downloading through a network.

It is noted that the program according to the present invention may cause the process to be executed by invoking a necessary module among program modules offered as part of an operating system (OS) of a computer with a predetermined timing in a predetermined sequence. In that case, the program itself does not include the above-described module, but the process is executed in cooperation with the OS. Such a program not including a module may also be covered by the program according to the present invention.

Moreover, the program according to the present invention may be offered as incorporated into part of another program. Also in such a case, the program itself does not include the module included in the above-described other program, and the process is executed in cooperation with the other program. Such a program incorporated into another program may also be covered by the program according to the present invention.

An offered program product is installed in a program storage unit, such as a hard disk, and is executed. It is noted that the program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A file processing system for processing a workflow file, comprising a plurality of file processing devices each having a touch panel for receiving input of a user operation,
said workflow file including body data and information defining a user who can process the workflow file,
said file processing system further comprising:
an identifying unit for, when a first file processing device among said plurality of file processing devices to which a first user who can process said workflow file logs in detects that a first gesture of identifying said workflow file and a second gesture of indicating a second user who will process said workflow file subsequently have been performed on said touch panel, identifying said second user based on said second gesture and said defining information included in said workflow file;
a reporting unit for reporting, to a second file processing device among said plurality of file processing devices corresponding to said second user, that identification as a user who will process said workflow file subsequently has been made by said identifying unit; and
an acquisition unit for, when said second file processing device detects that a third gesture for making a request for processing of said workflow file has been performed, causing said second file processing device to acquire said body data of said workflow file in accordance with said request,
said second gesture being a gesture of, continuously after at least one contact is made on said touch panel, moving said at least one contact toward an edge of said touch panel at a predetermined speed or higher, and then releasing said at least one contact at or near said edge of said touch panel, and
said identifying unit identifying said second user based on a direction in which said at least one contact is moved in said second gesture and said defining information included in said workflow file.

2. The file processing system according to claim 1, wherein
said defining information included in said workflow file includes information as to whether or not said workflow file has been processed for each user who can process said workflow file,
said file processing system further comprising an updating unit for updating said defining information included in said workflow file in accordance with said first gesture, wherein
when the user identified by said second gesture has not yet processed said workflow file in said defining information, said identifying unit identifies the user as said second user.

3. The file processing system according to claim 1, wherein said identifying unit previously stores correspondence between the direction in which said at least one contact is moved in said second gesture and a user, and when the user corresponding to the direction in which said at least one contact is moved in said second gesture is defined by said defining information as the user who can process said workflow file, identifies the user corresponding to the direction in which said at least one contact is moved as said second user.

4. The file processing system according to claim 1, wherein said identifying unit previously stores the position of each of said plurality of file processing devices, and when the user corresponding to said second file processing device located in the direction in which said at least one contact is moved in said second gesture relative to said first file processing device is defined by said defining information as the user who can process said workflow file, identifies the user corresponding to said second file processing device located in the direction in which said at least one contact is moved as said second user.

5. The file processing system according to claim 1, further comprising a management device, wherein
said management device includes said identifying unit and said reporting unit, and
said management device further includes a transmission unit for, when said request is received from said second file processing device, transmitting said body data of said workflow file to said second file processing device.

6. The file processing system according to claim 5, wherein
said management device further includes an authentication unit for conducting authentication whether or not a login user of said second file processing device having made said request is said second user, and
said transmission unit transmits said body data of said workflow file when said authentication succeeds.

7. The file processing system according to claim 1, wherein
said first gesture is a gesture of, continuously after two contacts are made on said touch panel, moving said two contacts in a direction that a spacing therebetween is decreased and then releasing said two contacts after being moved, and
said third gesture is a gesture of, continuously after two contacts are made on said touch panel, moving said two contacts in a direction that the spacing therebetween is increased and then releasing said two contacts after being moved.

8. A file processing system for processing a workflow file, comprising a plurality of file processing devices each having a touch panel for receiving input of a user operation,
said workflow file including body data and information defining an order of processing by users who can process the workflow file,
said file processing system further comprising:
an identifying unit for, when a first file processing device among said plurality of file processing devices to which a first user who can process said workflow file logs in detects that a first gesture of identifying said workflow file has been performed, identifying a user subsequent to said first user in said order of processing in said defining information included in said workflow file, as said second user;
a reporting unit for reporting, to a second file processing device among said plurality of file processing devices corresponding to said second user, that identification as a user who will process said workflow file subsequently has been made by said identifying unit; and
an acquisition unit for, when said second file processing device detects that a third gesture for making a request for processing of said workflow file has been performed, causing said second file processing device to acquire said body data of said workflow file in accordance with said request.

9. The file processing system according to claim 8, further comprising a management device, wherein
said management device includes said identifying unit and said reporting unit, and
said management device further includes a transmission unit for, when said request is received from said second file processing device, transmitting said body data of said workflow file to said second file processing device.

10. The file processing system according to claim 9, wherein
said management device further includes an authentication unit for conducting authentication whether or not a login user of said second file processing device having made said request is said second user, and
said transmission unit transmits said body data of said workflow file when said authentication succeeds.

11. The file processing system according to claim 8, wherein
said first gesture is a gesture of, continuously after two contacts are made on said touch panel, moving said two contacts in a direction that a spacing therebetween is decreased and then releasing said two contacts after being moved, and
said third gesture is a gesture of, continuously after two contacts are made on said touch panel, moving said two contacts in a direction that the spacing therebetween is increased and then releasing said two contacts after being moved.

12. A management device for managing processing of a workflow file in a file processing device, comprising a communication controller for controlling communications with a plurality of file processing devices,
said workflow file including body data and information defining a user who can process the workflow file,
said management device further comprising:
an identifying unit for, when information indicative that a first gesture of identifying said workflow file and a second gesture of indicating a second user who will process said workflow file subsequently have been performed is received from a first file processing device among said plurality of file processing devices to which a first user who can process said workflow file logs in, identifying said second user based on said second gesture and said defining information included in said workflow file;
a reporting unit for reporting, to a second file processing device among said plurality of file processing devices corresponding to said second user, that identification as a user who will process said workflow file subsequently has been made by said identifying unit; and
a transmission unit for, when information indicative that a third gesture for making a request for processing of said workflow file is received from said second file processing device, transmitting said body data of said workflow file to said second file processing device in accordance with said request.

13. The management device according to claim 12, wherein
said defining information included in said workflow file includes information as to whether or not said workflow file has been processed for each user who can process said workflow file,
said management device further comprising an updating unit for updating said defining information included in said workflow file based on said information received from said first file processing device, wherein
when the user identified by said second gesture has not yet processed said workflow file in said defining information, said identifying unit identifies the user as said second user.

14. The management device according to claim 12, wherein
said plurality of file processing devices each include a touch panel,
said second gesture is a gesture of, continuously after at least one contact is made on said touch panel, moving said at least one contact toward an edge of said touch panel at a predetermined speed or higher, and then releasing said at least one contact at or near said edge of said touch panel, and
said identifying unit identifies said second user based on a direction in which said at least one contact is moved in said second gesture and said defining information included in said workflow file.

15. The management device according to claim 14, wherein said identifying unit previously stores correspondence between the direction in which said at least one contact is moved in said second gesture and a user, and when the user corresponding to the direction in which said at least one contact is moved in said second gesture is defined by said defining information as the user who can process said workflow file, identifies the user corresponding to the direction in which said at least one contact is moved, as said second user.

16. The management device according to claim 14, wherein said identifying unit previously stores the position of each of said plurality of file processing devices, and when a user corresponding to said second file processing device located in the direction in which said at least one contact is moved in said second gesture relative to said first file processing device is defined by said defining information as the user who can process said workflow file, identifies the user corresponding to said second file processing device located in the direction in which said at least one contact is moved, as said second user.

17. The management device according to claim 12, further comprising an authentication unit for conducting authentication whether or not a login user of said second file processing device having made said request is said second user, wherein said transmission unit transmits said body data of said workflow file when said authentication succeeds.

18. A management device for managing processing of a workflow file in a file processing device, comprising a communication controller for controlling communications with a plurality of file processing devices,
said workflow file including body data and information defining an order of processing by users who can process the workflow file,
said management device further comprising:
an identifying unit for, when information indicative that a first gesture of identifying said workflow file has been performed is received from a first file processing device among said plurality of file processing devices to which a first user who can process said workflow file logs in, identifying a user subsequent to said first user in said order of processing in said defining information included in said workflow file, as said second user;
a reporting unit for reporting, to a second file processing device among said plurality of file processing devices corresponding to said second user, that identification as a user who will process said workflow file subsequently has been made by said identifying unit; and
a transmission unit for, when information indicative that a third gesture for making a request for processing of said workflow file is received from said second file processing device, transmitting said body data of said workflow file to said second file processing device in accordance with said request.

19. The management device according to claim 18, further comprising an authentication unit for conducting authentication whether or not a login user of said second file processing device having made said request is said second user, wherein
said transmission unit transmits said body data of said workflow file when said authentication succeeds.

20. A processing method in a file processing system for processing a workflow file,
said file processing system including a plurality of file processing devices each having a touch panel for receiving input of a user operation and a management device capable of communicating with said plurality of file processing devices,
said workflow file including body data and information defining a user who can process the workflow file, said processing method comprising the steps of:
transmitting, from a first file processing device among said plurality of file processing devices to which a first user who can process said workflow file logs in to said management device, information indicative that a first gesture of identifying said workflow file and a second gesture of indicating a second user who will process said workflow file subsequently have been performed;
in said management device, identifying said second user based on said second gesture and said defining information included in said workflow file;
reporting, from said management device to a second file processing device among said plurality of file processing devices corresponding to said second user, that identification as a user who will process said workflow file subsequently has been made in said step of identifying; and
when information indicative that a third gesture for making a request for processing of said workflow file is received from said second file processing device, transmitting said body data of said workflow file from said management device to said second file processing device.

21. A processing method in a file processing system for processing a workflow file,
said file processing system including a plurality of file processing devices each having a touch panel for receiving input of a user operation and a management device capable of communicating with said plurality of file processing devices,
said workflow file including body data and information defining an order of processing by users who can process the workflow file, said processing method comprising the steps of:
transmitting, from a first file processing device among said plurality of file processing devices to which a first user who can process said workflow file logs in to said management device, information indicative that a first gesture of identifying said workflow file has been performed;
in said management device, identifying a user subsequent to said first user in said order of processing in said defining information included in said workflow file, as a second user;
reporting, from said management device to a second file processing device among said plurality of file processing devices corresponding to said second user, that identification as a user who will process said workflow file subsequently has been made in said step of identifying; and
when information indicative that a third gesture for making a request for processing of said workflow file is received from said second file processing device, transmitting said body data of said workflow file from said management device to said second file processing device.
